(19) United States
(12) Patent Application Publication
(10) Pub. No.: US 2008/0267849 A1
(43) Pub. Date: Oct. 30, 2008

(54) PROCESSES FOR THE OXIDATION OF CARBON MONOXIDE IN A GAS STREAM CONTAINING HCL

(75) Inventors: Michel Haas, Dormagen (DE); Frank Gerhartz, Leverkusen (DE); Aurel Wolf, Wulfrath (DE); Oliver Felix-Karl Schluter, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/110,468

(22) Filed: Apr. 28, 2008

(30) Foreign Application Priority Data
Apr. 26, 2007 (DE) 102007020096.1

(51) Int. Cl. B01D 53/34

(52) U.S. Cl. 423/247

(57) ABSTRACT

Processes comprising: providing a gas stream comprising hydrogen chloride and carbon monoxide; and oxidizing at least a portion of the carbon monoxide in the gas stream in the presence of a catalyst to form a product gas comprising hydrogen chloride and carbon dioxide; wherein the catalyst comprises tin dioxide and a ruthenium compound comprising at least one element selected from the group consisting of oxygen and chlorine.

### BACKGROUND OF THE INVENTION

Fuller et al. (J. of Cat., 29, 441-450, 1973) describe CO oxidation over pure tin dioxide in the range of 180-210° C. The (partial) deactivation of the SnO₂ is said to be a disadvantage.

U.S. Pat. No. 4,117,082 discloses catalysts for the oxidation of CO based on SnO₂ and Rh, Ru, Ir or Pt, the SnO₂ and the metal halide being calcined (fired) at 800° C. in an electric oven. The oxidation of CO is achieved with the catalysts according to the invention at very low temperatures, but there is no indication that such catalysts are suitable for use in the presence of a gas containing HCl. At the same time, the preparation method is energy- and therefore cost-intensive because of the high calcining temperatures.

European Patent Publication No. EP 0107471 B1 discloses the oxidation of CO over catalysts which contain SnO₂, Pd and one or more metals from the group consisting of Pt, Ru, Rh and Ir. The metals are supported in metallic form on SnO₂, and it cannot be seen from the description or examples whether the catalysts claimed are also suitable for use in the presence of a gas containing HCl.

Chiodini et al. (Int. J. In. Mat., 2, 2000, 355-363) describe the oxidation of metallic Ru on SnO₂. The supported catalyst is prepared using Ru carbonyl, so that exclusively metallic Ru is formed. Such catalysts have a low activity in HCl oxidation and are therefore not suitable for use in the presence of gas containing HCl.

In the publication of Narkhede et al. (Z. Phys. Chem. 219, 2005, 979-995) and the literature references cited therein, the structure-activity relationships of polycrystalline RuO₂ in the oxidation of CO are explained. Here also, the oxidation does not take place in the presence of gas containing HCl.

Japanese Patent Publication Nos. JP2001246231 and JP2002226205 describe the oxidation of CO to CO₂ in an HCl-containing stream over an Ru or RuO₂ catalyst. In addition, International Patent Application No. WO2006/135074 describes the oxidation of CO to CO₂ over a catalyst prepared by reaction of RuO₂ with HCl at temperatures of >500° C. According to the application, this catalyst is also said to be suitable for use under Deacon conditions.

In general, the catalytic oxidation of carbon monoxide to CO₂ in the presence of HCl can be difficult to perform because of the inhibition of the catalyst induced by HCl.

A large number of chemical processes for reaction with chlorine or phosgene, such as the preparation of isocyanates or chlorinations of aromatics, lead to an inevitable generation of hydrogen chloride. Generally, this hydrogen chloride is converted back into chlorine by electrolysis. Compared with this very energy-intensive method, direct oxidation of hydrogen chloride with pure oxygen or an oxygen-containing gas over heterogeneous catalysts (the so-called Deacon process) in accordance with

4HCl+O₂ [symbol] 2Cl₂+2H₂O

offers significant advantages with respect to the energy consumption.

A relatively large amount of carbon monoxide (CO) can be present as an impurity in the HCl waste gas in process steps for the preparation of isocyanates, such as phosgenation. In commonly employed liquid phase phosgenation, a CO content in the range of 0.5-3 vol. % is as a rule found in the HCl waste gas of the column for washing out the phosgene. In the trend-setting gas phase phosgenation (e.g., German Patent Publication Nos. DE 4217019 A1 and DE 10307141 A1), higher amounts of CO (3 to more than 5%) are also to be expected, since in this process preferably no condensation of phosgene, and associated separating off of the carbon monoxide, is carried out before the phosgenation.

In the conventional catalytic HCl oxidation with oxygen, the most diverse catalysts are used, e.g. based on ruthenium, chromium, copper etc. Such catalysts are described, for example, in German and European Patent Publication Nos. DE 1567788 A1, EP 251731 A2, EP 936184 A2, EP 761593 A1, EP 711599 A1 and DE 10250131 A1. Needless to say, these can simultaneously function as oxidation catalysts for any secondary components present, such as carbon monoxide or organic compounds. However, the catalytic oxidation of carbon monoxide to carbon dioxide is extremely exothermic and causes uncontrolled local increases in temperature on the surface of the heterogeneous catalyst (hot spot) such that a deactivation can take place. In fact, the oxidation of 5% carbon monoxide in an inert gas (N₂) at an intake temperature of 250° C. (Deacon operating temperatures 200-450° C.) would cause an increase in temperature of far above 200 degrees in an adiabatic reaction. One cause of the catalyst deactivation lies in the microstructural change in the catalyst surface, e.g. by sintering processes, due to the hot spot formation.

The adsorption of carbon monoxide on the surface of the catalyst moreover is not to be ruled out. The formation of metal carbonyls can take place reversibly or irreversibly and is thus in direct competition with the HCl oxidation. In fact, carbon monoxide can enter into very stable bonds with some elements even at high temperatures and can thus cause an inhibition of the desired target reaction. A further disadvantage could arise due to the volatility of these metal carbonyls, as a result of which not inconsiderable amounts of catalyst are lost and in addition require an expensive purification step, depending on the use.

A catalyst deactivation can also be caused in the Deacon process both by destruction of the catalyst and by limitation of the stability. Competition between hydrogen chloride and carbon monoxide can also lead to an inhibition of the desired HCl oxidation reaction. For optimum operation of the Deacon process, the lowest possible content of carbon monoxide in the HCl gas is accordingly necessary in order to ensure a long life of the catalyst employed.

In order to avoid such problems, various approaches have been described for carrying out an oxidation of CO in the HCl stream on the basis of known catalysts in a preliminary reactor connected in series (JP 62-270404, JP 2003-171103). In this case the gas mixture is passed isothermally in the presence of oxygen on to a catalyst in which a ruthenium compound is supported on zirconium oxide, or a palladium-supported catalyst.

### BRIEF SUMMARY OF THE INVENTION

The present invention relates, in general to processes for the oxidation of HCl with oxygen over catalysts in the gas phase, and further relates to the oxidation of CO in a stream containing HCl, and subsequent use in a Deacon process.

The present invention provides efficient processes for separating off the carbon monoxide from an HCl-containing gas which is subsequently to be fed, in particular, to a Deacon or Deacon-like process for oxidation of the hydrogen chloride with oxygen, and in particular for simplifying coupling with a Deacon process.

The invention by which such improvements can be achieved provides a process for conversion of carbon monoxide into CO₂ by catalytic gas phase oxidation of CO by means of oxygen in a gas stream containing at least hydrogen chloride and carbon monoxide, wherein the catalyst comprises tin dioxide and a ruthenium compound containing oxygen and/or chlorine.

The present invention includes processes for the preparation of chlorine from a gas containing hydrogen chloride and carbon monoxide, which comprise the step of catalyzed oxidation of the carbon monoxide and optionally further oxidizable constituents to carbon dioxide with oxygen in a preliminary reactor under isothermal or adiabatic conditions and subsequent catalytic reaction of the HCl with oxygen.

One embodiment of the present invention includes processes comprising: providing a gas stream comprising hydrogen chloride and carbon monoxide; and oxidizing at least a portion of the carbon monoxide in the gas stream in the presence of a catalyst to form a product gas comprising hydrogen chloride and carbon dioxide; wherein the catalyst comprises tin dioxide and a ruthenium compound comprising at least one element selected from the group consisting of oxygen and chlorine.

Another embodiment of the present invention includes processes comprising: (a) reacting chlorine with a stoichiometric excess of carbon monoxide in the presence of a catalyst to form phosgene; (b) reacting the phosgene with an organic amine to form an organic isocyanate and a gas stream comprising hydrogen chloride and carbon monoxide; (c) separating the organic isocyanate from the gas stream; (d) oxidizing at least a portion of the carbon monoxide in the gas stream in the presence of a catalyst to form a product gas comprising hydrogen chloride and carbon dioxide, wherein the catalyst comprises tin dioxide and a ruthenium compound comprising at least one element selected from the group consisting of oxygen and chlorine; (e) catalytically oxidizing the hydrogen chloride in the product gas to form chlorine; and (f) optionally recycling at least a portion of the chlorine to the reaction to form phosgene.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a gas stream” herein or in the appended claims can refer to a single stream or more than one stream. Additionally, all numerical values, unless otherwise specifically noted, are understood to be modified by the word “about.”

Since CO oxidation over a catalyst takes place very rapidly, in the various embodiments of the present invention, a small catalyst bed can be employed, the temperature of which can be controlled significantly more easily in order to avoid hot spots and which renders possible an easy and uncomplicated exchange of small amounts of catalyst in the event of poisoning with relatively large amounts of CO, which damage the catalyst, and thus functions as a sacrificial bed. In addition, the hot spot can be controlled via the addition of oxygen and the amount of inert gas. If only small amounts of oxygen are added (stoichiometric or slightly in excess of stoichiometric based on CO), the HCl oxidation is suppressed due to the very rapid kinetics for the CO oxidation, and the additive evolution of heat thus prevents the HCl oxidation. The process can be operated adiabatically or isothermally. In both cases the evolution of heat of the CO oxidation can be used further, e.g., by generating steam.

A ruthenium compound, preferably a ruthenium oxide, a ruthenium oxychloride or a ruthenium chloride, in particular supported on tin oxide, and one or more additional support materials such as titanium dioxide, aluminum oxide, silicon oxide, aluminum-silicon mixed oxides, zeolites, oxides and mixed oxides (e.g. of titanium, zirconium, vanadium, aluminum, silicon etc.), metal sulfates or clay, is employed here as the preferred catalyst. The choice of possible supports, however, is not limited to this list. Tin oxide, in particular in the rutile form, is preferred as the support material. This catalyst surprisingly showed a very high activity in the CO oxidation in the presence of HCl.

The catalyst is obtainable, in particular by a process which comprises application of an aqueous solution or suspension of at least one halide-containing ruthenium compound to tin dioxide and subsequent drying and calcining of the halide-containing ruthenium compound.

An aqueous solution of RuCl₃ is particularly preferably used.

Preferably, the CO oxidation is carried out at up to 450° C., preferably 250 to 350° C.

The present invention furthermore relates to a process for the preparation of chlorine from a crude gas containing hydrogen chloride and carbon monoxide, which comprises at least:
(a) catalytic oxidation of the carbon monoxide and optionally further oxidizable constituents to carbon dioxide with oxygen by employing a catalyst in which a ruthenium compound is present on tin oxide as a support, and which is optionally doped with further elements, and
(b) catalytic oxidation of the hydrogen chloride in the gas resulting from a) with oxygen to form chlorine.

The catalytic oxidation of the carbon monoxide in (a) can be carried out, in particular, under the abovementioned preferred conditions of the CO oxidation.

The gas containing hydrogen chloride and carbon monoxide employed in the processes according to the present invention is preferably the waste gas of a phosgenation reaction for the formation of organic isocyanates. However, it can also be, for example, a waste gas of chlorination reactions of hydrocarbons.

The gas containing hydrogen chloride and carbon monoxide to be reacted according to the invention can comprise further oxidizable constituents, such as, in particular, hydrocarbons, substituted or unsubstituted, saturated or unsaturated. These are in general oxidized in step a) likewise with the formation of CO₂.

The content of hydrogen chloride in the gas containing hydrogen chloride and carbon monoxide entering into the catalytic oxidation of the carbon monoxide can be, for example, in the range of from 20 to 99.5 vol. %, preferably 30 to 99.5 vol. %.

The content of carbon monoxide in the gas containing hydrogen chloride and carbon monoxide entering into a preliminary reactor for the catalytic oxidation of the carbon monoxide can be, for example, in the range of from 0.5 to 15 vol. %, preferably 1 to 10 vol. %. The processes according to the various embodiments of the present invention render it possible to tolerate considerably higher amounts of carbon monoxide in the waste gase of the phosgenation process in the event of coupling with an isocyanate process, and thus to avoid involved and cost-intensive purification steps.

The oxidation of carbon monoxide and the further oxidizable constituents optionally present is expediently operated by addition of oxygen, oxygen-enriched air or air. The addition of oxygen or oxygen-containing gas can be stoichiometric, based on the carbon monoxide content, or can be operated with an oxygen excess. By adjusting the oxygen excess and, where appropriate, an optional addition of inert gas, preferably nitrogen, the removal of heat from the catalyst in step a) and the exit temperature of the process gas can optionally be controlled.

The intake temperature of the gas containing hydrogen chloride and carbon monoxide at the entry of a preliminary reactor for the catalytic oxidation of the carbon monoxide is preferably 0 to 450° C., preferably 200 to 400° C.

A more precise control of the progress of the CO oxidation is possible here in particular by monitoring the hot spot temperature. The course of the possible poisoning of the catalyst in the preliminary reactor can thus be monitored and the exact time for exchange of the catalyst can be determined. Two redundantly constructed preliminary reactors can be used in order to avoid a shutdown during exchange of the catalyst (sequential operation of the preliminary reactors).

The catalytic oxidation of the carbon monoxide is preferably carried out under those pressure conditions which correspond to the operating pressure of a subsequent oxidation of the HCl. The pressure is in general 1 to 100 bar, preferably 1 to 50 bar, particularly preferably 1 to 25 bar. In order to compensate the drop in pressure in the catalyst heap, a slightly increased pressure, based on the exit pressure, is preferably used.

The content of carbon monoxide is expediently reduced according to the invention to less than 1 vol. %, preferably to less than 0.5 vol. %, even more preferably to less than 0.1 vol. %.

The gas emerging from the preliminary reactor of step a) essentially contains HCl, CO₂, O₂ and further secondary constituents, such as nitrogen. The unreacted oxygen can then be employed in the subsequent course for the HCl oxidation in step b).

The low-CO gas emerging from the preliminary reactor according to step a) optionally arrives at the reactor for oxidation of the hydrogen chloride of step b) via a heat exchanger. The heat exchanger between the reactor of step b) and the preliminary reactor of step a) is expediently coupled in a controlled manner with the preliminary reactor of step a). The temperature of the gas passed on to the HCl oxidation in the subsequent course can be adjusted exactly with the heat exchanger. As required, heat can be removed by this means if the exit temperature is too high, e.g. by generation of steam. If the exit temperature is too low, the process gases can be brought to the desired temperature by supplying heat. Such a process additionally contributes towards compensating variations in the CO content and therefore changes in the rate of heating up.

In step b) of the processes according to the invention, the oxidation of the hydrogen chloride with oxygen to form chlorine is carried out in a manner known per se.

Thus, in the Deacon process of step b), hydrogen chloride is oxidized with oxygen in an exothermic equilibrium reaction to give chlorine, steam being obtained. Conventional reaction temperatures are 150 to 500° C., conventional reaction pressures are 1 to 50 bar. Since it is an equilibrium reaction, it is expedient to operate at the lowest possible temperatures at which the catalyst still has an adequate activity. It is furthermore expedient to employ oxygen in amounts in excess of the stoichiometric amount. For example, a two- to four-fold excess of oxygen is conventional. Since no losses in selectivity are to be feared, it may be economically advantageous to operate under relatively high pressures and accordingly over longer dwell times compared with normal pressure. Suitable catalysts contain ruthenium oxide, ruthenium chloride or other ruthenium compounds on silicon dioxide, aluminum oxide, titanium dioxide or zirconium dioxide as a support. Suitable catalysts can be obtained, for example, by application of ruthenium chloride to the support and subsequent drying or drying and calcining. Suitable catalysts can furthermore contain chromium(III) oxide.

Conventional reaction apparatuses in which the catalytic hydrogen chloride oxidation is carried out are a fixed bed or fluidized bed reactor. The hydrogen chloride oxidation can be carried out in several stages. The catalytic hydrogen chloride oxidation can likewise be carried out adiabatically, but preferably isothermally or approximately isothermally, discontinuously, preferably continuously as a fluidized or fixed bed process, preferably as a fixed bed process, particularly preferably in tube bundle reactors over heterogeneous catalysts at reactor temperatures of from 180 to 500 C., preferably 200 to 400° C., particularly preferably 220 to 350° C. under a pressure of from 1 to 25 bar, preferably 1.2 to 20 bar, particularly preferably 1.5 to 17 bar and in particular 2.0 to 15 bar. In the adiabatic, the isothermal or approximately isothermal procedure, several, that is to say 2 to 10, preferably 2 to 6, particularly preferably 2 to 5, in particular 2 to 3 reactors connected in series, optionally with intermediate cooling, can also be employed. The hydrogen chloride can be added either completely together with the oxygen before the first reactor, or distributed over the various reactors. This connection of individual reactors in series can also be combined in one apparatus.

A preferred embodiment comprises employing a structured catalyst heap in which the catalyst activity increases in the direction of flow. Such a structuring of the catalyst heap can be carried out by different impregnation of the catalyst support with the active composition or by different dilution of the catalyst with an inert material. Rings, cylinders or balls of titanium dioxide, zirconium dioxide or mixtures thereof aluminum oxide, steatite, ceramic, glass, graphite, stainless steel and/or nickel alloys can be employed, for example, as the inert material. Suitable heterogeneous catalysts are, in particular, ruthenium compounds or copper compounds on support materials, which can also be doped, and optionally doped ruthenium catalysts are preferred. Suitable support materials are, for example, silicon dioxide, graphite, titanium dioxide having the rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof. The copper or the ruthenium supported catalysts can be obtained, for example, by impregnation of the support material with aqueous solutions of CuCl₂ or RuCl₃ and optionally a promoter for doping, preferably in the form of their chlorides.

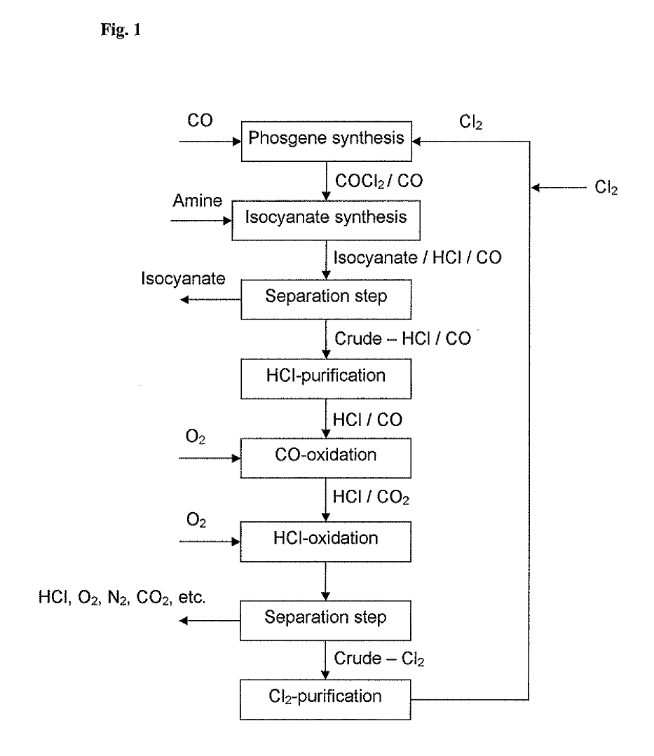

The conversion of hydrogen chloride in a single pass can be limited to 15 to 95%, preferably 40 to 90%, particularly preferably 50 to 85%. Some or all of the unreacted hydrogen chloride can be recycled into the catalytic hydrogen chloride oxidation after being separated off. The catalytic hydrogen chloride oxidation has the advantage over the production of chlorine by hydrogen chloride electrolysis that no expensive electrical energy is required, that no hydrogen, which is unacceptable from safety aspects, is obtained as a linked product, and that the hydrogen chloride fed in does not have to be completely pure. The heat of reaction of the catalytic hydrogen chloride oxidation can be used in an advantageous manner for generation of high pressure steam. This can be used for operation of the phosgenation reactor and the isocyanate distillation columns. The chlorine is separated off in a manner known per se from the chlorine-containing gas resulting in step b). Chlorine obtained by the process according to the invention can then be reacted with carbon monoxide by processes known from the prior art to give phosgene, which can be employed for the preparation of TDI or MDI from TDA or, respectively, MDA. The hydrogen chloride formed in turn in the phosgenation of TDA and MDA can then be converted into chlorine in accordance with step b) by the processes described. FIG. 1 shows a process according to an embodiment of the invention such as can be incorporated into the isocyanate synthesis.

The carbon monoxide content in the HCl stream is reduced significantly by the process according to the invention, as a result of which a deactivation of the Deacon catalyst at the next stage due to an uncontrolled increase in temperature is slowed down. At the same time, the feed gas for the HCl oxidation is heated up to the operating temperature required for the HCl oxidation without a high consumption of external energy.

The invention will now be described in further detail with reference to the following non-limiting examples.

### EXAMPLES

10 g ruthenium chloride n-hydrate are dissolved in 34 ml water, 200 g support (SnO₂/Al₂O₃ (85:15 w/w); 1.5 mm) are added and the components are mixed thoroughly until the solution has been absorbed by the support. The support impregnated in this way is left to stand for 1 h. The moist solid is finally dried in the unwashed form in a muffle oven for 4 h at 60° C. and 16 h at 250° C.

5 g of the dried catalyst were employed at various temperatures and gas streams. The amount of carbon monoxide and carbon dioxide in the intake stream and in the exit stream was determined by gas chromatography by known methods. Table 1 contains the experiment conditions and the resulting CO conversion to CO₂.

TABLE 1

| Temp. ° C. | N₂ l/h | O₂ l/h | HCl l/h | CO l/h | Conversion % |
|---|---|---|---|---|---|
| 250 | 3.6 | 0.25 | 1.1 | 0.25 | 51% |
| 350 | 25 | 20 | 5 | 0.25 | 90% |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
providing a gas stream comprising hydrogen chloride and carbon monoxide; and
oxidizing at least a portion of the carbon monoxide in the gas stream in the presence of a catalyst to form a product gas comprising hydrogen chloride and carbon dioxide;
wherein the catalyst comprises tin dioxide and a ruthenium compound comprising at least one element selected from the group consisting of oxygen and chlorine.

2. The process according to claim 1, wherein the ruthenium compound comprises at least one selected from the group consisting of a ruthenium oxide, a ruthenium oxychloride, and a ruthenium chloride.

3. The process according to claim 1, wherein the catalyst comprises the ruthenium compound supported on the tin dioxide.

4. The process according to claim 1, wherein the catalyst comprises the ruthenium compound supported on the tin dioxide and one or more additional support materials selected from the group consisting of metal oxides, mixed metal oxides, zeolites, metal sulfates, clays, and mixtures thereof.

5. The process according to claim 1, wherein the catalyst comprises the ruthenium compound supported on the tin oxide and one or more additional support materials selected from the group consisting of titanium dioxide, aluminum oxide, silicon oxide, aluminum-silicon mixed oxides, zeolites, metal sulfates, clays, and mixtures thereof.

6. The process according to claim 1, wherein the catalyst is prepared by a process comprising applying an aqueous solution or suspension of at least one halide-containing ruthenium compound to tin dioxide; and subsequently drying and calcining the halide-containing ruthenium compound.

7. The process according to claim 1, wherein the ruthenium compound comprises RuCl₃.

8. The process according to claim 6, wherein the at least one halide-containing ruthenium compound comprises RuCl₃.

9. The process according to claim 1, wherein the oxidation is carried out at a temperature of up to 450° C.

10. The process according to claim 1, wherein the oxidation is carried out at a temperature of 250 to 350° C.

11. The process according to claim 1, wherein the tin dioxide comprises rutile tin dioxide.

12. The process according to claim 1, further comprising catalytically oxidizing the hydrogen chloride in the product gas to form chlorine.

13. The process according to claim 12, further comprising heat exchange in a heat exchanger disposed between a first reactor for carrying out the oxidation of at least a portion of the carbon monoxide in the gas stream and a second reactor for carrying out the oxidation of hydrogen chloride.

14. The process according to claim 1, wherein the gas stream further comprises a hydrocarbon, and at least a portion of the hydrocarbon is oxidized during the oxidation reaction to form additional carbon dioxide.

15. The process according to claim 1, wherein the oxidation reaction is carried out with an oxygen source selected from the group consisting of oxygen, oxygen-enriched air, air, and combinations thereof.

16. The process according to claim 1, wherein the hydrogen chloride is present in the gas stream in an amount of 20 to 99.5 vol. %.

17. The process according to claim 1, wherein the carbon monoxide is present in the gas stream in an amount of 0.5 to 15 vol. %.

18. The process according to claim 1, wherein the carbon monoxide is present in the product gas stream in an amount of less than 1 vol. %.

19. The process according to claim 12, wherein the carbon monoxide is present in the product gas stream in an amount of less than 1 vol. %.

20. The process according to claim 12, wherein the catalytic oxidation of hydrogen chloride is carried out in the presence of a catalyst comprising at least one metal selected from the group consisting of ruthenium, gold, palladium, platinum, osmium, iridium, silver, copper, potassium, rhenium, chromium, and mixtures thereof.

21. The process according to claim 20, wherein the catalyst is absorbed on to a support material.

22. The process according to claim 21, wherein the support material comprises a component selected from the group consisting of tin oxide, titanium dioxide, aluminum oxide, silicon oxide, aluminum-silicon mixed oxides, zeolites, oxides and mixed oxides, metal sulfates, clay, and mixtures thereof.

23. A process comprising:
(a) reacting chlorine with a stoichiometric excess of carbon monoxide in the presence of a catalyst to form phosgene;
(b) reacting the phosgene with an organic amine to form an organic isocyanate and a gas stream comprising hydrogen chloride and carbon monoxide;
(c) separating the organic isocyanate from the gas stream;
(d) oxidizing at least a portion of the carbon monoxide in the gas stream in the presence of a catalyst to form a product gas comprising hydrogen chloride and carbon dioxide, wherein the catalyst comprises tin dioxide and a ruthenium compound comprising at least one element selected from the group consisting of oxygen and chlorine;
(e) catalytically oxidizing the hydrogen chloride in the product gas to form chlorine; and
(f) optionally recycling at least a portion of the chlorine to the reaction to form phosgene.
